(19) United States
(12) Patent Application Publication
(10) Pub. No.: US 2010/0169578 A1
(43) Pub. Date: Jul. 1, 2010

(54) CACHE TAG MEMORY

(75) Inventors: Robert NYCHKA, Canton, TX (US); William M. JOHNSON, Austin, TX (US); Thang M. TRAN, Austin, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,210

(22) Filed: Dec. 31, 2008

(51) Int. Cl. G06F 12/08

(52) U.S. Cl. 711/138; 711/E12.021

(57) ABSTRACT

A system comprises tag memories and data memories. Sources use the tag memories with the data memories as a cache. Arbitration of a cache request is replayed, based on an arbitration miss and way hit, without accessing the tag memories. A method comprises receiving a cache request sent by a source out of a plurality of sources. The sources use tag memories with data memories as a cache. The method further comprises arbitrating the cache request, and replaying arbitration, based on an arbitration miss and way hit, without accessing the tag memories.

### BACKGROUND

In computing systems, the time needed to bring data to the processor is long when compared to the time needed to use the data. For example, a typical access time for main memory is 60 ns. A 100 MHz processor can execute most instructions in 10 ns. Because data is used faster than data is retrieved, a bottle neck of time forms at the input to the processor. A cache helps by decreasing the time it takes to move data to and from the processor. Cache is small high-speed memory, usually static random access memory (“SRAM”), that contains the most recently accessed pieces of main memory. A typical access time for SRAM is 15 ns. Therefore, cache memory provides access times up to 3 to 4 times faster than main memory. However, SRAM is several times more expensive than main memory, consumes more power than main memory, and is less dense than main memory, making a large cache expensive. As such, refinements to memory allocation can produce savings having a significant impact on performance and cost.

### SUMMARY

System and methods for tag memory allocation are described herein. In at least some disclosed embodiments, a system includes tag memories and data memories. Sources use the tag memories with the data memories as a cache, and arbitration of a cache request is replayed, based on an arbitration miss and way hit, without accessing the tag memories. Replaying arbitration without accessing the tag memories allows for, inter alia, decreased power consumption, decreased latency, increased coherency, decreased conflicts, and decreased blocked allocations.

In even further disclosed embodiments, a method includes receiving a cache request sent by a source out of a plurality of sources, the sources using tag memories with data memories as a cache. The method further includes arbitrating the cache request and replaying arbitration, based on an arbitration miss and way hit, without accessing the tag memories. Replaying arbitration without accessing the tag memories allows for, inter alia, decreased power consumption, decreased latency, increased coherency, decreased conflicts, and decreased blocked allocations.

These and other features and advantages will be more clearly understood from the following detailed description taken in conjunction with the accompanying drawings and claims.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates a system of tag allocation in accordance with at least one embodiment;

FIG. 2 illustrates tag allocation arbitration scenarios in accordance with at least one embodiment;

FIG. 3 illustrates a method of tag allocation in accordance with at least one embodiment; and

FIG. 4 illustrates a method of tag allocation in accordance with at least one embodiment.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through an indirect electrical connection via other devices and connections, through a direct optical connection, etc. Additionally, the term “system” refers to a collection of two or more hardware components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one having ordinary skill in the art will understand that the following description has broad application, and the discussion of any embodiment is meant only to be exemplary of that embodiment, and not intended to intimate that the scope of the disclosure, including the claims, is limited to that embodiment.

Systems and method are disclosed allowing for a significant saving of resources. Using a separate tag memory for each source allows for, inter alia, decreased setup time, increased coherency, decreased conflicts, and decreased blocked allocations. Replaying arbitration without accessing the tag memories allows for, inter alia, decreased power consumption, decreased latency, increased coherency, decreased conflicts, and decreased blocked allocations.

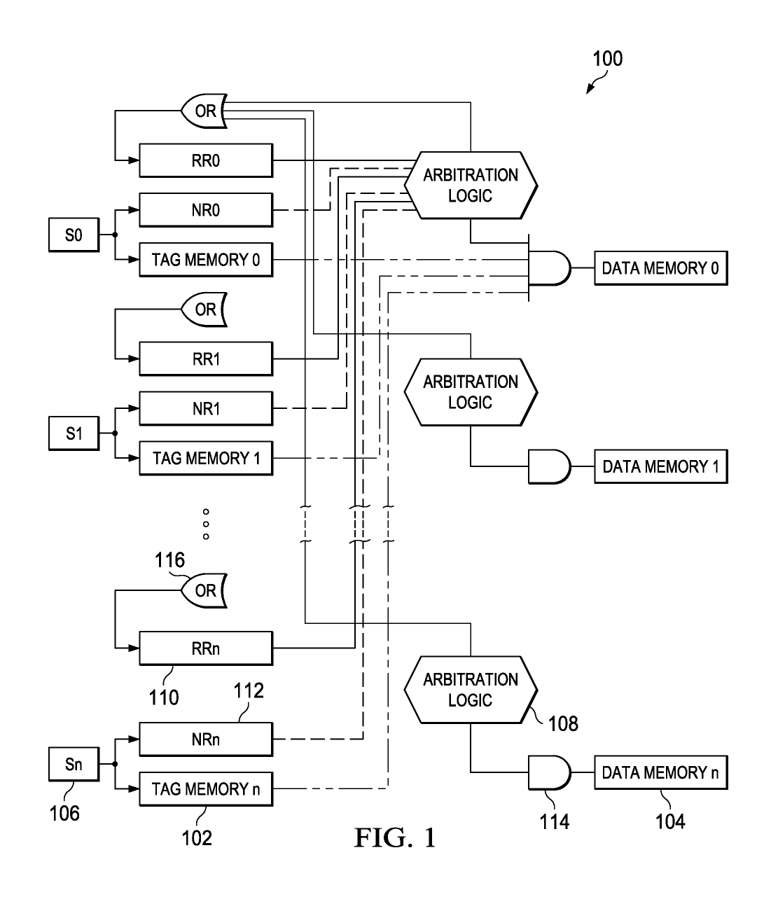

FIG. 1 illustrates a system 100 of tag allocation. The system 100 comprises tag memories 102 and data memories 104. Sources 106 use the tag memories 102 with the data memories 104 as a cache. The sources 106 can be any hardware or software that requests data. For example, a source 106 can be a processor, a bus, a program, etc. A cache comprises a database of entries. Each entry has data that is associated with (e.g. a copy of) data in main memory. The data is stored in a data memory 104 of the cache. Each entry also has a tag, which is associated with (e.g. specifies) the address of the data in the main memory. The tag is stored in the tag memories 102 of the cache. When a source 106 requests access to data, the cache is checked first via a cache request because the cache will provide faster access to the data than main memory. If an entry can be found with a tag matching the address of the requested data, the data from the data memory of the entry is accessed instead of the data in the main memory. This situation is a “cache hit.” The percentage of requests that result in cache hits is known as the hit rate or hit ratio of the cache. Sometimes the cache does not contain the requested data. This situation is a cache miss. Cache hits are preferable to cache misses because hits cost less time and resources.

In at least one embodiment, each source 106 uses a separate tag memory 102. For example, source 0 (“S0”) uses only tag memory 0, source 1 (“S1”) uses only tag memory 1, etc. Also, each source 106 is configured to use each data memory 104 in at least one embodiment. For example, S0 is configured to use data memory 0, data memory 1, etc.; S1 is configured to use data memory 0, data memory 1, etc.; and so forth. As such, each individual tag memory, e.g. tag memory 0, can refer to data in any data memory, e.g. data memory 1. Accordingly, each tag memory 102 is updated such that each of the tag memories 102 comprises identical contents. Updating the tag memories 102 preserves the association between tags in the tag memories 102 and the data in the data memories 104. For example, if tag memory 1 changes contents due to data memory 0 changing contents, then all other tag memories, tag memory 0 and tag memory n, will be updated to reflect the change in tag memory 1.

In some embodiments, the system 100 can be configured to operate using any number of data memories. For example, the system 100 can be configured to operate as a cache with two data memories 104. The system 100 may then be reconfigured to operate as a cache with twenty data memories 104. In at least one embodiment, either 1, 2, 3, 4, 5, 6, 7, 8, 9, 10, 11, 12, 13, 14, 15, or 16 data memories 104 are used.

Main memory can be divided into cache pages, where the size of each page is equal to the size of the cache. Accordingly, each line of main memory corresponds to a line in the cache, and each line in the cache corresponds to as many lines in the main memory as there are cache pages. Hence, two pieces of data corresponding to the same line in the cache cannot both be stored simultaneously in the cache. Such a situation can be remedied by limiting page size, but results in a tradeoff in increased resources necessary to determine a cache hit or miss. For example, if each page size is limited to the size of half the cache, then two lines of cache must be checked for a cache hit or miss, one line in each “way,” or number of pages in the whole cache. For example the system 100 can be configured to operate as a cache using two ways, i.e. checking two lines for a cache hit or miss. The system 100 may then be reconfigured to operate as a cache using nine ways, i.e. checking nine lines for a cache hit or miss. In at least one embodiment, the system 100 is configured to operate using any number of ways. In at least one embodiment 2, 3, 4, 5, 6, 7, or 8 ways are used.

Larger caches have better hit rates but longer latencies than smaller caches. To address this tradeoff, many computers use multiple levels of cache, with small fast caches backed up by larger slower caches. A cache that is accessed first to determine whether the cache system hits or misses is a level 1 cache. A cache that is accessed second, after a level 1 cache is accessed, to determine whether the cache system hits or misses is a level 2 cache. In at least one embodiment, the system 100 is configured to operate as a level 1 cache and a level 2 cache. For example, the system 100 may be configured to operate as a level 1 cache. The system 100 may then be reconfigured to operate as a level 2 cache.

In at least one embodiment, the system 100 comprises separate arbitration logic 108 for each of the data memories 104. Arbitration logic 108 determines the order in which cache requests are processed. The cache request that “wins” the arbitration accesses the data memories 104 first, and the cache requests that “lose” are “replayed,” i.e. arbitrated again without the winner. A cache request “loss” is an arbitration miss. Preferably, arbitration is replayed, based on an arbitration miss and way hit, without accessing the tag memories 102. As such, the tag memories 102 are free to be accessed based on other cache requests at the time the tag memory would have been accessed if the tag memory was accessed for replay based on the arbitration miss. Also, the hits and misses generated from one source 106 do not block hits and misses from another source 106. In at least one embodiment, the system comprises replay registers 110, each replay register 110 paired with a tag memory 102. The replay registers 110 allow arbitration replay to bypass the tag memory paired with the replay register, and each replay register receives as input a signal indicating an arbitration miss by each set of arbitration logic 108. A logical OR 116 preferably combines the signals from each set of arbitration logic 108 for each replay register 110. Preferably, arbitration occurs prior to way calculation by way calculation logic 114, and arbitration assumes a tag hit. Way calculation, i.e. checking each way for a hit or miss, preferably occurs after arbitration and the data memories 104 are not accessed on a miss. Arbitration is not replayed if all ways in the tag memory lookup miss.

In at least one embodiment, the system 100 comprises next registers 112. Each next register 112 is paired with a separate tag memory 102. The next registers 112 forward cache requests to the arbitration logic 108 such that the arbitration occurs in parallel with tag lookup in a tag memory 102 paired with the next register 112. As such, the tag output of the tag memory is used only during way calculation by the way calculation logic 114.

For clarity, some of the lines in FIG. 1 have been omitted. For example, only the inputs to the arbitration logic 108 coupled to data memory 0 is shown. The inputs for the arbitration logic 108 coupled to data memory 1 and data memory n are the same. Only the inputs for the way selection logic 114 coupled to data memory 0 are shown. The inputs for the way selection logic 114 coupled to data memory 1 and data memory n are the same excepting that each way selection logic 114 is coupled to a unique arbitration logic. Only the inputs for the logical OR 116 coupled to RR0 are shown. The inputs for the logical ORs coupled to RR1 and RRn are the same.

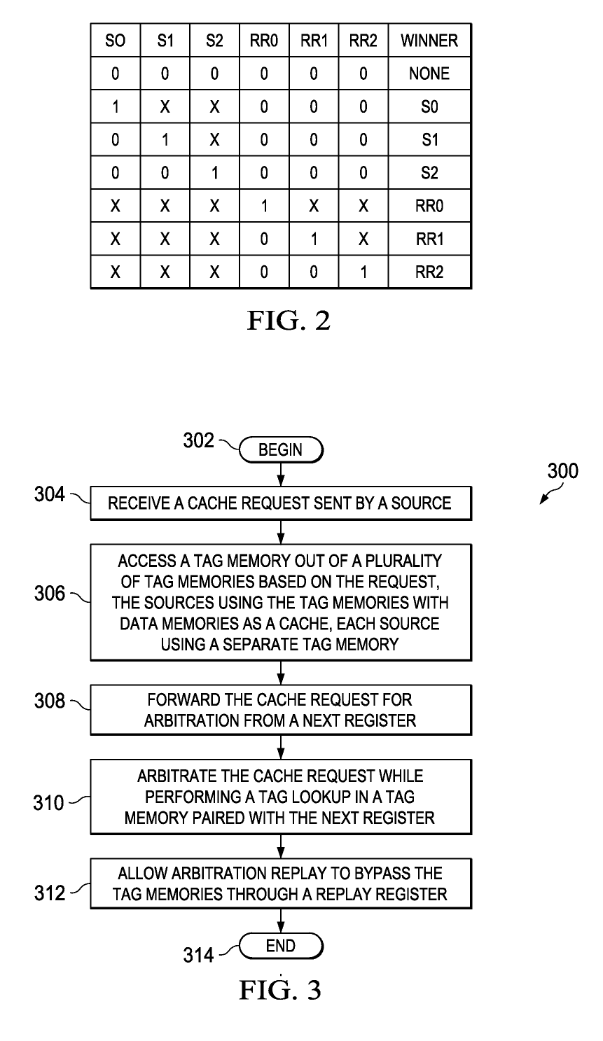

Preferably, the data memories 104 are organized as a banked data array. As such, the least significant bit determines priority, a smaller number given preference over a larger number. Consequently, the number of bank conflicts is reduced. A bank conflict occurs when accesses to the same data memory 104 occurs simultaneously. FIG. 2 illustrates tag allocation arbitration scenarios using three sources 106 and three replay registers 110, where the lower numbered sources 106 are given priority except during replay, where the lower numbered replay registers 110 are given priority. If more sources 106 and replay registers 110 are included in the system 100, the arbitration is performed with decreasing priority, according to the pattern displayed showing sources 1 and 2 of having decreasing priority in arbitration than source 0. The top row is a header row listing each source 106 and replay register 110, and the final column lists the winner. The first row illustrates that no source 106 or replay register 110 win when none are arbitrated. The second row illustrates that S0 wins when none of the replay registers 110 are arbitrated, no matter the state of any other source 106. The third row illustrates that S1 wins when none of the replay registers or S0 is arbitrated, no matter the state of higher numbered sources. The fourth row illustrates that S2 wins when none of the replay registers, S0, or S1 is arbitrated, no matter the state of higher numbered sources. The fifth row illustrates that RR0 wins when arbitrated no matter the state of any sources 106 or other replay registers 110. The sixth row illustrates that RR1 wins when RR0 is not arbitrated no matter the state of sources 106 or higher numbered replay registers 110. The seventh row illustrates that RR2 wins when RR0 and RR1 are not arbitrated no matter the state of sources 106 or higher numbered replay registers 110. In at least one embodiment, the replay registers 110 and next registers 112 are associated or paired with the tag memories 102, e.g., one replay register, next register, and tag memory per association. In another embodiment, the replay registers 110 and next registers 112 are associated or paired with the arbitration logic 108, e.g., one replay register, next register, and set of arbitration logic per association.

FIG. 3 illustrates a method 300 of tag allocation beginning at 302 and ending at 314. At 304, a cache request sent by a source out of plurality of sources is received. At 306, a tag memory out of a plurality of tag memories is accessed based on the request, the sources using the tag memories with data memories as a cache, each source using a separate tag memory. In at least one embodiment, the method 300 comprises updating the tag memories such that the tag memories comprise identical contents. At 308, the cache request is forwarded for arbitration from a next register out of a plurality of next registers, each of the next registers paired with a separate tag memory. At 310, the cache request is arbitrated while performing a tag lookup in a tag memory paired with the next register. Preferably, the requests for each of the data memories are arbitrated using separate arbitration logic. In at least one embodiment, arbitration is replayed based on an arbitration miss and way hit, without accessing the tag memories. At 312, arbitration replay is allowed to bypass the tag memories through a replay register. As such, a tag memory is accessed, based on a second cache request, at the time the tag memory would have been accessed if the tag memory was accessed for replay based on the arbitration miss. Arbitration is not replayed if all ways in the tag memory lookup miss. In at least one embodiment, each source request is serialized, first to tag memory, then to data memory. In another embodiment, tag memory and data memory are accessed concurrently. Hence, the data memory access is speculative. In a third embodiment, one request is serialized, and another request causes concurrent tag memory and data memory access.

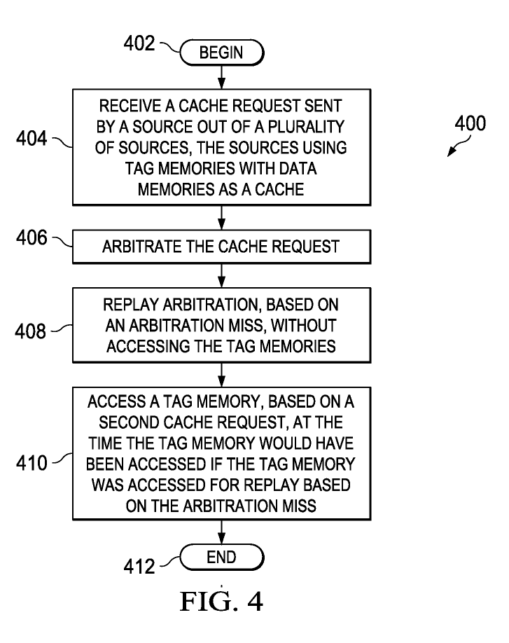

FIG. 4 illustrates a method 400 of tag allocation beginning at 402 and ending at 412. At 404, a cache request sent by a source out of a plurality of sources is received, the sources using tag memories with data memories as a cache. Preferably, each source uses a separate tag memory. At 406, the cache request is arbitrated. Preferably the method 400 comprises arbitrating requests for each of the data memories using separate arbitration logic. In at least one embodiment, arbitrating the cache request further comprises forwarding, for arbitration, the cache request from a next register out of a plurality of next registers, each next register paired with a separate tag memory.

At 408, arbitration is replayed, based on an arbitration miss and way hit, without accessing the tag memories. Preferably, arbitration replay is allowed to bypass the tag memories through a replay register. As such, at 410, a tag memory is accessed, based on a second cache request, at the time the tag memory would have been accessed if the tag memory was accessed for replay based on the arbitration miss. Preferably, the method 400 comprises accessing a tag memory paired with the next register in parallel with arbitrating the cache request, and calculating a way after arbitrating the cache request. In at least one embodiment, the method 400 further comprises updating the tag memories such that the tag memories comprise identical contents. Arbitration is not replayed if all ways in the tag memory lookup miss.

Other conditions and combinations of conditions will become apparent to those skilled in the art, including the combination of the conditions described above, and all such conditions and combinations are within the scope of the present disclosure. Additionally, audio or visual alerts may be triggered upon successful completion of any action described herein, upon unsuccessful actions described herein, and upon errors.

The above disclosure is meant to be illustrative of the principles and various embodiment of the present invention. Numerous variations and modifications will become apparent to those skilled in the art once the above disclosure is fully appreciated. Also, the order of the actions shown in FIGS. 3 and 4 can be varied from order shown, and two or more of the actions may be performed concurrently. It is intended that the following claims be interpreted to embrace all variations and modifications.

1. A system, comprising:
tag memories; and
data memories;
wherein sources use the tag memories with the data memories as a cache; and
wherein arbitration of a cache request is replayed, based on an arbitration miss and way hit, without accessing the tag memories.

2. The system of claim 1, wherein a tag memory is accessed, based on a second cache request, at the time the tag memory would have been accessed if the tag memory was accessed for replay based on the arbitration miss.

3. The system of claim 1, further comprising next registers, each next register paired with a separate tag memory.

4. The system of claim 3, wherein a next register forwards, for arbitration, the cache request; and wherein the arbitration occurs in parallel with tag lookup.

5. The system of claim 4, further comprising replay registers, each replay register paired with a tag memory, a replay register allowing arbitration replay to bypass the tag memory paired with the replay register.

6. The system of claim 1, wherein each of the sources uses a separate tag memory.

7. The system of claim 1, wherein a tag memory and data memory are accessed concurrently based on a second cache request.

8. The system of claim 1, further comprising next registers, each next register paired with a separate set of arbitration logic.

9. The system of claim 1, wherein the data memories are organized as a banked data array.

10. The system of claim 1, wherein the data memories and the tag memories together is configurable for operation as a level 1 cache and a level 2 cache.

11. The system of claim 1, further comprising separate arbitration logic for each of the data memories.

12. A method, comprising:
receiving a cache request sent by a source out of a plurality of sources, the sources using tag memories with data memories as a cache;
arbitrating the cache request; and
replaying arbitration, based on an arbitration miss and way hit, without accessing the tag memories.

13. The method of claim 12, further comprising accessing a tag memory, based on a second cache request, at the time the tag memory would have been accessed if the tag memory was accessed for replay based on the arbitration miss.

14. The method of claim 12, further comprising updating the tag memories such that the tag memories comprise identical contents.

15. The method of claim 12, further comprising arbitrating requests for each of the data memories using separate arbitration logic.

16. The method of claim 12, wherein replaying arbitration comprises replaying arbitration, based on an arbitration miss and way hit, without accessing the tag memories, each source using a separate tag memory.

17. The method of claim 12, wherein arbitrating the cache request further comprises forwarding, for arbitration, the cache request from a next register out of a plurality of next registers, each next register paired with a separate tag memory.

18. The method of claim 17, further comprising accessing a tag memory paired with the next register in parallel with arbitrating the cache request.

19. The method of claim 18, further comprising calculating a way after arbitrating the cache request.

20. The method of claim 12, further comprising allowing arbitration replay to bypass the tag memories through a replay register.
